(19) United States
(12) Patent Application Publication
(10) Pub. No.: US 2020/0167806 A1
(43) Pub. Date: May 28, 2020

(54) SYSTEMS AND METHODS FOR RECEIVING AND STORING CUSTOMER FEEDBACK

(71) Applicant: WOODENSHARK LLC, Wilmington, DE (US)

(72) Inventor: Dmitry GORILOVSKY, Wilmington, DE (US)

(21) Appl. No.: 15/781,166

(22) PCT Filed: Dec. 5, 2016
(86) PCT No.: PCT/GB2016/053826

§ 371 Date: Jun. 4, 2018

(30) Foreign Application Priority Data
Dec. 4, 2015 (GB) 1521429.9

(51) Int. Cl. G06Q 30/02; G06Q 30/00; G06Q 10/08; G06Q 30/06

(52) U.S. Cl. CPC G06Q 30/0203; G06Q 30/0185; G06Q 10/0838; G06Q 10/087; G06Q 30/0631; G06Q 30/0607; G06Q 30/0633

(57) ABSTRACT

A system for receiving and storing unbiased user feedback about user perception of beverage quality, the system including a server, a computer database and a plurality of containers each including a beverage. Each container includes a sealed container containing the beverage, wherein each container has no marking which identifies the beverage to a user. The server is configured to store user account data; receive an order for a first container from a user terminal in communication with the server, in relation to the user account, and to store the order; receive a confirmation of delivery of the first container to the user street address; receive feedback identifying the user's perception of a beverage quality of the first beverage, and store the feedback in the computer database.

### BACKGROUND OF THE INVENTION

### 1. Field of the Invention

The field of the invention relates to systems for receiving and storing user feedback about user perception of beverage quality (eg. wine quality), and to related methods and computer program products.

### 2. Technical Background

A cognitive bias refers to a systematic pattern of deviation from rationality in judgment, in which inferences about a subject may be drawn in an unjustified manner. An example is confirmation bias, which is the tendency to search for or interpret information in a way that confirms one's preconceptions. Another example is framing bias, in which the mental representations, interpretations, or simplifications of reality lead to bias in decision making.

Cognitive bias may affect a user's evaluation of a beverage. For example, a user may be presented with a bottle of Italian wine and a bottle of Bulgarian wine, which are unmarked with respect to their contents. The user may taste the wines and report that the tastes do not differ significantly. However, if the user had known in advance the identities of the wines, and if the user had a belief that Italian wine is expected to be better on average than Bulgarian wine, then cognitive bias may have led the user to report that the Italian wine tasted better than the Bulgarian wine. Such biases are evidently problematic when trying to evaluate beverage quality in an objective manner.

There is a need for a method and for a system to eliminate or to reduce user cognitive bias when evaluating beverages, so as to provide a computer database of user evaluation of beverages which is relatively free from cognitive bias. Such a database may then be used to inform on the relative quality of different beverages (e.g. different wines). Such a database may be useful in a beverage delivery system eg. in a wine delivery system.

### 3. Discussion of Related Art

TW201037625 (A) (English Abstract) discloses an alcoholic beverage favors consulting system was to construct an alcoholic beverage evaluation model by using grey relational analysis and expert system. Samples were subjected to find the main compounds and analyze the volatile elements. The elements studied included five components: dry extract, ph, titratable acidity, alcohol included. Grey relational analysis is built basically on these six elements. This system wills also presents the results of surveys conducted in Taiwan to determine the sensory effects of alcoholic beverages. These surveys will be used to test and verify the model is feasible. The alcoholic beverage favors consulting system performs seven main functions: (1) user information input; (2) alcoholic beverage parameter setting; (3) text report generating; (4) results represent with photograph; (5) alcoholic beverage information querying; (6) decision making and reasoning; (7) reasoning processes explanation. This system may lead to helpful for assist consumer in choosing alcoholic beverages. It will also be very useful in hospitality industry.

However, TW201037625 (A) (English Abstract) does not disclose a method or a system to eliminate or to reduce user cognitive bias when evaluating beverages, so as to provide a computer database of user evaluation of beverages which is relatively free from cognitive bias.

### SUMMARY OF THE INVENTION

According to a first aspect of the invention, there is provided a system for receiving and storing unbiased user feedback about user perception of beverage quality, the system including a server, a computer database and a plurality of containers each including a respective beverage, each container including the respective beverage comprising a sealed container containing the respective beverage, wherein each container including the respective beverage has no marking which identifies the respective beverage to a user, wherein

(i) the server is configured to receive a registration of a user account from a user terminal in communication with the server, the user account including user account data including a user name and a user street address of a user, and the server is configured to store the user account data;

(ii) the server is configured to receive an order for a first container including a first beverage from the plurality of containers each including a respective beverage, wherein the server is configured to receive the order from a user terminal in communication with the server, in relation to the user account, and to store the order;

(iii) the server is configured to receive a confirmation of delivery of the first container including the first beverage to the user street address;

(iv) the server is configured to receive feedback in relation to the user account and the first container including the first beverage that was confirmed to have been delivered to the user street address, the feedback identifying the user's perception of a beverage quality of the first beverage, and

(v) the server is configured to store the feedback in the computer database.

An advantage is that the system includes a computer database which stores unbiased user feedback about user perception of beverage quality, which therefore overcomes the problem of cognitive bias in stored user feedback regarding beverages. The problem of cognitive bias in stored user feedback regarding beverages is a technical problem, because the problem may be overcome with a suitable technical approach. The architecture of the system contributes to the solution of a technical problem, because the combination of the feedback gathering system and the use of containers, each including a respective beverage, which have no marking which identifies the respective beverage to a user enables the system to solve the technical problem. The perceived problem is overcome by the claimed invention.

The user terminal may be in wireless communication with the server. The user terminal may be in wired communication with the server. The user terminal may be a desktop computer, a laptop computer, a tablet computer, a smart TV, a wireless device or a smartphone.

The system may be one in which the beverage is an alcoholic beverage.

The system may be one in which the alcoholic beverage is wine, beer, cider, whisky, vodka, or sake. An advantage is that the system may be used to gather unbiased user feedback for a wide variety of beverages.

The system may be one in which each container including the respective beverage is a wine bottle including a wine.

The system may be one in which the beverage is a non-alcoholic beverage.

The system may be one in which the non-alcoholic beverage is supplied in dry form.

The system may be one in which the non-alcoholic beverage is tea or coffee.

The system may be one in which in response to receiving the feedback identifying the user's perception of the beverage quality, the server is configured to transmit the identity of the beverage to the user. An advantage is that the user is incentivized to participate, because they find out the identity of the beverage after they have sampled it.

The system may be one in which the server is configured to transmit the identity of the beverage to the user instantly, for display on a user terminal.

The system may be one in which the system includes a computer-based recommendation engine operable to select a beverage for a next order, based on beverage evaluations which have been stored at the server. An advantage is that the user may receive more suitable beverages, than randomly selected beverages.

The system may be one in which the beverage evaluations include beverage evaluations from a panel of experts.

The system may be one in which the beverage evaluations include beverage evaluations from users registered at the server.

The system may be one in which the beverage evaluations include wine evaluations.

The system may be one in which the system is configured to use beverage evaluations of the user, and the computer-based recommendation engine, to select a beverage for the next order which is more suitable for the user than if the beverage selected for the next order were to be selected at random.

The system may be one in which the server is configured to provide a user with an option to view their favorite beverages as stored in the computer database.

The system may be one in which the favorite beverages as stored in the computer database, are the user's favorite beverages from past orders. An advantage is that a user may access their favorite beverages, without having to remember all of them, and may then order a selected favorite beverage.

The system may be one in which the server is configured to arrange for sending off the next beverage delivery, soon or immediately after receiving a customer evaluation of the previously delivered beverage.

The system may be one in which the server is configured to provide a user with an option to adjust an order, when ordering a first or subsequent beverage delivery.

The system may be one in which the server provides the user with an option to adjust an order quantity, or wherein the server provides the user with an option to select a type of beverage.

The system may be one in which the server is configured to provide a user with an option to view on a user terminal their previously received beverages as stored in the computer database.

The system may be one in which the server is configured to provide a user with an option to order a previously received beverage. An advantage is that a user may access their previously received beverages, without having to remember all of them, and may then order a selected previously received beverage.

The system may be one in which the server is configured to provide a user with an option to order a previously received beverage, at a retail price, rather than at a fixed price for beverage containers for which the delivered beverage does not have an identifier through which the user can identify the beverage.

The system may be one in which a container including a respective beverage which has no marking which identifies the respective beverage to a user comprises a container from which usual labeling has been removed from the container.

The system may be one in which a container including a respective beverage which has no marking which identifies the respective beverage to a user comprises a container including a non-transparent coating which covers the container, or which covers its identifying labeling. An advantage is that containers including a respective beverage which are suitable for use in the system may be generated quickly and cheaply.

The system may be one in which the non-transparent coating is a plastic or silicone coating. An advantage is a coating which is robust for a wide range of use scenarios.

The system may be one in which a container including a respective beverage which has no marking which identifies the respective beverage to a user includes an identifier.

The system may be one in which the identifier is for inventory purposes. An advantage is that the container and its beverage can always be identified in the inventory system, even though a typical user will not be able to derive the beverage identity from the container.

The system may be one in which the identifier is a serial number, a one dimensional bar code or a two dimensional pattern code.

The system may be one in which the server is configured to receive user input of the identifier, and to verify if the identifier is a valid identifier, and to store whether or not the identifier is valid. An advantage is that errors in the delivery process can be identified readily.

The system may be one in which

(vi) the server is configured to receive a subsequent order for a second container including a second beverage from the plurality of containers each including a respective beverage, wherein the server is configured to receive the order from a user terminal in communication with the server, in relation to the user account, and to store the order;

(vii) the server is configured to receive a confirmation of delivery of the second container including the second beverage to the user street address;

(viii) the server is configured to receive feedback in relation to the user account and the second container including the second beverage that was confirmed to have been delivered to the user street address, the feedback identifying the user's perception of a beverage quality of the second beverage, and

(ix) the server is configured to store the feedback in the computer database.

An advantage is that the system may provide a large number of subsequent deliveries.

According to a second aspect of the invention, there is provided a computer-implemented method for receiving and storing unbiased user feedback about user perception of beverage quality, the method including the steps of:

(i) a server receiving a registration of a user account from a user terminal in communication with the server, the user account including user account data including a user name and a user street address of a user, and the server storing the user account data;

(ii) the server receiving an order for a container including a beverage, the container including the beverage comprising a sealed container containing the beverage, wherein the container including the beverage has no marking which identifies the beverage to the user, the server receiving the order from a user terminal in communication with the server, in relation to the user account, and storing the order;

(iii) the server receiving a confirmation of delivery of the container including the beverage to the user street address;

(iv) the server receiving feedback in relation to the user account and the container including the beverage that was confirmed to have been delivered to the user street address, the feedback identifying the user's perception of a beverage quality of the beverage, and

(v) storing the feedback in a computer database.

The method may be one wherein the beverage is an alcoholic beverage.

The method may be one wherein the alcoholic beverage is wine, beer, cider, whisky, vodka, or sake.

The method may be one wherein each container including the respective beverage is a wine bottle including a wine.

The method may be one wherein the beverage is a non-alcoholic beverage.

The method may be one including the step of supplying the non-alcoholic beverage in dry form.

The method may be one wherein the non-alcoholic beverage is tea or coffee.

The method may be one including delivering unbranded beverages.

The method may be one including delivering beverages for a fixed price.

The method may be one including delivering a beverage to a street address which was supplied by the user to the server when the customer registered at the server.

The method may be one including the customer sampling or consuming delivered beverage or beverages and rating the beverage or beverages, and the customer supplying the rating or ratings to the server.

The method may be one including in response to supplying a beverage rating to the server, the customer receiving the identity of the beverage which they had sampled or consumed, which is sent by the server for display on a user terminal.

The method may be one wherein the customer receives instantly the identity of the beverage.

The method may be one including a computer-based recommendation engine being used to select the beverage for the next order, based on beverage evaluations which have been stored at the server.

The method may be one wherein the beverage evaluations are from a panel of experts, or wherein the beverage evaluations are from users of the beverage delivery service, or wherein the beverage evaluations are from a panel of experts and from users of the beverage delivery service.

The method may be one wherein the beverage evaluations are wine evaluations.

The method may be one wherein using beverage evaluations of the user, and the computer-based recommendation engine, a beverage is selected for the next order which is more suitable for the user than if the beverage selected for the next order were to be selected at random.

The method may be one wherein the computer-based recommendation engine selects the next beverage for delivery in the way that average cost per ordered beverage container, which is beverage underlying cost+delivery, divided by the number of containers, is lower than a fixed price per delivered beverage.

The method may be one including the server offering a plurality of different price levels per delivered beverage which does not have an identifier through which the user can identify the beverage.

The method may be one including the server providing a user with an option to view their favorite beverages as stored in the computer database.

The method may be one in which their favorite beverages as stored in the computer database are their favorite beverages from past orders.

The method may be one including the server providing a user with an option to order their favorite beverages from past orders for a retail price.

The method may be one including the server arranging for sending off the next beverage delivery, soon or immediately after receiving a customer evaluation of the previously delivered beverage.

The method may be one including the server providing a user with an option to adjust an order, when ordering a first or subsequent beverage delivery.

The method may be one wherein the option is to adjust the order quantity, or to select the type of beverage.

The method may be one including charging a customer only when he rates the beverage starting from first order.

The method may be one including charging a customer for the first order when he signs-up and then charging him for the next beverage delivery when he rates the most recently delivered order.

The method may be one including the server providing a user with an option to view on a user terminal their previously received beverages as stored in the computer database.

The method may be one including the server providing a user with an option to order a previously received beverage, at a retail price, rather than at a fixed price for beverage containers for which the delivered beverage does not have an identifier through which the user can identify the beverage.

The method may be one including preparing a beverage container such that the delivered beverage does not have an identifier through which the user can identify the beverage, by covering the container, or its identifying labeling, with a non-transparent coating.

The method may be one wherein the non-transparent coating is a plastic or silicone.

The method may be one including preparing a beverage container such that the delivered beverage does not have an identifier through which the user can identify the beverage, by removing the usual labeling from the container.

The method may be one in which the beverage container includes an identifier.

The method may be one wherein the identifier is for inventory purposes.

The method may be one wherein the identifier includes a serial number, a one dimensional bar code or a two dimensional pattern code.

The method may be one including the server receiving from a user an entry of the identifier and the server storing a result of whether or not the delivered beverage container is the correct beverage container.

The method may be one including in response to receiving the rating at the server, a subsequent beverage delivery is arranged to be sent by the server, and received by the user, and the customer samples or consumes the subsequently delivered beverage, and then sends a rating of the subsequently delivered beverage from a user terminal in communication with a server, to the server.

The method may be one wherein the customer is then charged for the subsequent beverage delivery, and the process repeats from the sending of the subsequent beverage delivery, onwards.

The method may be one including the steps of

(vi) the server receiving a subsequent order for a second container including a second beverage from the plurality of containers each including a respective beverage, the server receiving the order from a user terminal in communication with the server, in relation to the user account, and storing the order;

(vii) the server receiving a confirmation of delivery of the second container including the second beverage to the user street address;

(viii) the server receiving feedback in relation to the user account and the second container including the second beverage that was confirmed to have been delivered to the user street address, the feedback identifying the user's perception of a beverage quality of the second beverage, and

(ix) the server storing the feedback in the computer database.

According to a third aspect of the invention, there is provided a computer program product executable on a server processor, for receiving and storing unbiased user feedback about user perception of beverage quality, the computer program product executable on the server processor to cause the server:

(i) to receive a registration of a user account from a user terminal, the user account including user account data including a user name and a user street address of a user, and to store the user account data;

(ii) to receive an order for a container including a beverage, the container including the beverage comprising a sealed container containing the beverage, wherein the container including the beverage has no marking which identifies the beverage to the user, the server receiving the order from a user terminal, in relation to the user account, and to store the order;

(iii) to receive a confirmation of delivery of the container including the beverage to the user street address;

(iv) to receive feedback in relation to the user account and the container including the beverage that was confirmed to have been delivered to the user street address, the feedback identifying the user's perception of a beverage quality of the beverage, and

(v) to store the feedback in a computer database.

The computer program product may be arranged to perform a method of any aspect of the second aspect of the invention.

### BRIEF DESCRIPTION OF THE FIGURES

Aspects of the invention will now be described, by way of example(s), with reference to the following Figures, in which:

FIG. 1 shows an example process diagram.

FIG. 2 shows an example process diagram.

FIG. 3 shows an example process diagram.

FIG. 4 shows an example process diagram.

FIG. 5 shows an example of a bottle including a wine, the bottle including the wine comprising a sealed bottle containing the wine, wherein the bottle including the wine has no marking which identifies the wine to the user.

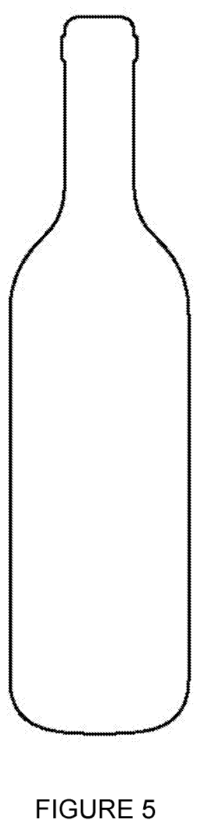

FIG. 6 shows an example of a system including a server, a computer database, a user terminal in communication with the server, and a plurality of containers each including a respective beverage, each container including the respective beverage comprising a sealed container containing the respective beverage, wherein each container including the respective beverage has no marking which identifies the respective beverage to a user, wherein

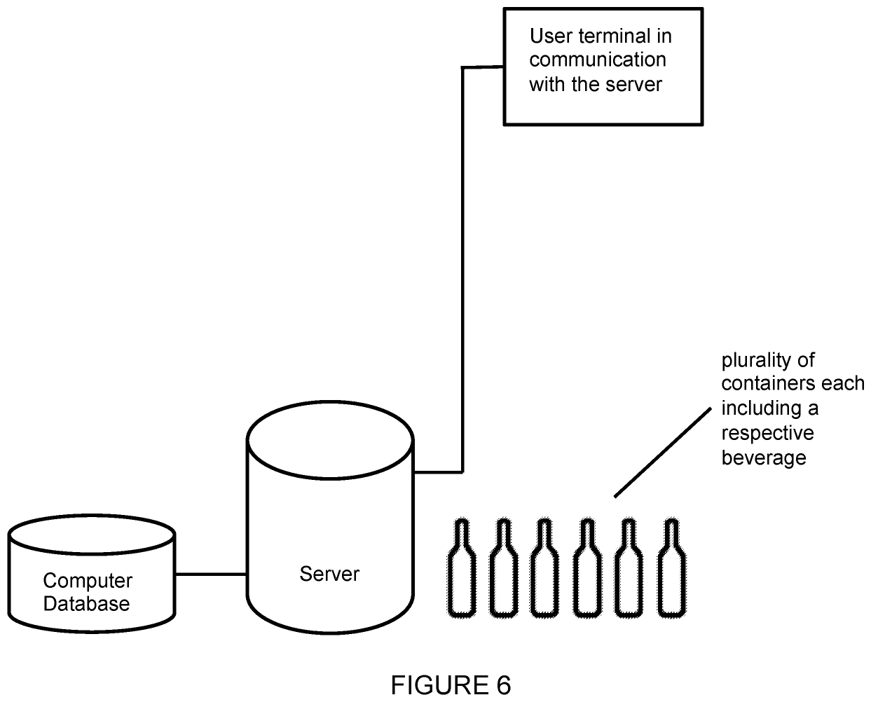

(i) the server is configured to receive a registration of a user account from the user terminal in communication with the server, the user account including user account data including a user name and a user street address of a user, and the server is configured to store the user account data;

(ii) the server is configured to receive an order for a first container including a first beverage from the plurality of containers each including a respective beverage, wherein the server is configured to receive the order from the user terminal in communication with the server, in relation to the user account, and to store the order; (iii) the server is configured to receive a confirmation of delivery of the first container including the first beverage to the user street address;

(iv) the server is configured to receive feedback in relation to the user account and the first container including the first beverage that was confirmed to have been delivered to the user street address, the feedback identifying the user's perception of a beverage quality of the first beverage, and

(v) the server is configured to store the feedback in the computer database.

### DETAILED DESCRIPTION

There is provided a beverage delivery service which delivers sealed containers containing the beverage, eg. a wine delivery service which delivers sealed wine bottles containing wine. The skilled person will appreciate that the beverage delivery service may deliver alcoholic beverages such as wine, beer, cider, whisky, vodka, sake, or non-alcoholic beverages such as tea or coffee. In the case of non-alcoholic beverages, the beverages may be supplied in dry form (e.g. tea leaves, coffee powder) which may be mixed with water (e.g. hot water) to form the beverage for consumption. In the beverage delivery service (eg. wine delivery service) the following may be provided.

A customer signs-up for the beverage (eg. wine) delivery service. This may be performed by the customer registering at a server. The customer may place a delivery order which is received at the server.

The service delivers unbranded beverages (eg. wines) or at least beverages without an identifier through which the user can identify the beverage. These beverages may be delivered for a fixed price. These beverages may be delivered to a street address which was supplied by the user to the server when the customer registered at the server.

The customer samples or consumes the delivered beverage or beverages and rates the beverage or beverages, which may be wines. The customer may supply the rating or ratings to the server. The server may store the received rating or ratings in a computer database. In response to supplying a beverage rating to the server, the customer may receive (eg. instantly) the identity of the beverage (eg. wine name and year) which they had sampled or consumed, which may be sent by the server for display on a user terminal.

A computer-based recommendation engine may be used to select the beverage (eg. wine) for the next order, based on beverage evaluations which have been stored at the server. The beverage evaluations may be from a panel of experts. The beverage evaluations may be from users of the beverage delivery service. The beverage evaluations may be from a panel of experts and from users of the beverage delivery service. The beverage evaluations may be wine evaluations. Using beverage (e.g. wine) evaluations of the user, and the computer-based recommendation engine, a beverage (e.g. wine) may be selected for the next order which is more suitable for the user than if the beverage (e.g. wine) selected for the next order were to be selected at random. In this way, improved selection of the beverage (e.g. wine) for the next order may be obtained.

The computer-based recommendation engine may select the next beverage for delivery in the way that average cost per ordered beverage container (i.e. beverage (eg. wine) underlying cost+delivery, divided by the number of containers (eg. bottles)) is lower than the fixed price per delivered beverage (eg. wine bottle). In this way, the delivery service makes a profit on each beverage that is delivered, in which the delivered beverage does not have an identifier through which the user can identify the beverage.

The beverage delivery service may offer a plurality of different price levels per delivered beverage which does not have an identifier through which the user can identify the beverage (eg. fixed price for the unlabeled wine bottle). This way a user can e.g. select a higher priced beverage to have a higher probability of receiving a more expensive beverage eg. wine.

The server may provide a user with the option to view their favorite beverages as stored in the computer database, which may be their favorite beverages (eg. wines) from past orders. The server may provide a user with the option to order their favorite beverages (eg. wines) from past orders for a retail (eg. fair market) price (not for fixed price for unbranded beverage (eg. wine bottle)).

The beverage delivery service may send off the next beverage (eg. wine bottle) delivery, soon or immediately after receiving a customer evaluation of the previously delivered beverage.

When ordering a first or subsequent beverage delivery, the server may provide a user with the option to adjust the order. The order quantity may be user adjustable. The type of beverage may be user selectable eg. for wines the type may be selected from red/white/sparkling/rose.

In terms of billing arrangements, various implementations may be implemented. For example, a customer may be charged only when he rates the beverage (eg. wine) starting from first order. For example, a customer may be charged for the first order when he signs-up and then charge him for the next beverage delivery (eg. wine bottle) when he rates the most recently delivered order.

The server may provide a user with the option to view on a user terminal their previously received beverages as stored in the computer database. The server may provide a user with the option to order a previously received beverage, but at the retail (eg. typical market) price, rather than at a fixed price for beverage containers for which the delivered beverage does not have an identifier through which the user can identify the beverage.

When a beverage container (e.g. wine bottle) is prepared such that the delivered beverage does not have an identifier through which the user can identify the beverage, this may be performed by covering the container (or its identifying labeling) with a non-transparent coating such as a plastic or silicone, rather than removing the usual labeling from the container. Alternatively, when a beverage container (e.g. wine bottle) is prepared such that the delivered beverage does not have an identifier through which the user can identify the beverage, this may be performed by removing the usual labeling from the container.

Although a beverage container for delivery may not have an identifier through which the user can identify the beverage, the beverage container may still have an identifier eg. for identification for inventory purposes, such as a serial number, a one dimensional bar code or a two dimensional pattern code (eg. a QR (Quick Response) code). After delivery, the user may then enter the identifier, which is then supplied to the server, so the server may confirm that the delivered beverage container is the correct beverage container.

First Example Process

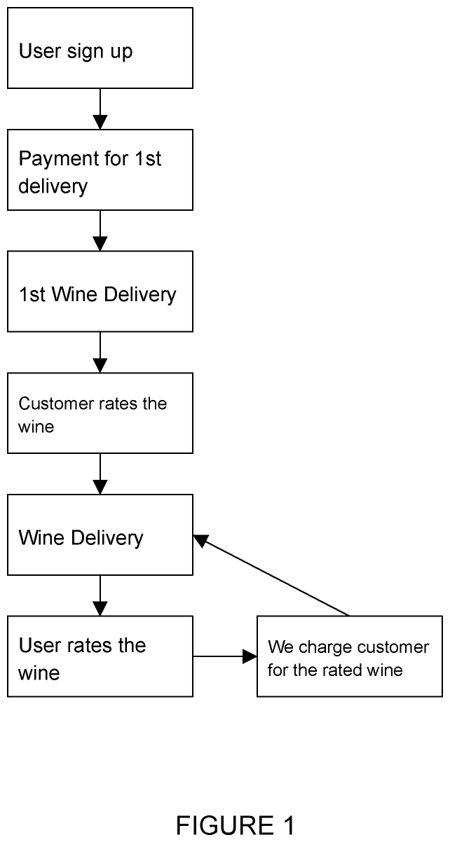

In a first example process, a user signs up to a wine delivery service, eg. by signing up using a user terminal in communication with a server. The service (eg. the server) requests and receives a payment from the user for the first wine delivery. The first wine delivery is sent by the service, and received by the user. The customer samples or consumes the wine, then sends a rating of the wine eg. from a user terminal in communication with a server, to the server. In response to receiving the rating (eg. at the server), a subsequent wine delivery is sent by the service, and received by the user. The customer samples or consumes the subsequently delivered wine, then sends a rating of the subsequently delivered wine eg. from a user terminal in communication with a server, to the server. The customer is then charged for the subsequent wine delivery, and the process repeats from the sending of the subsequent wine delivery, onwards. An example process diagram is shown in FIG. 1.

Second Example Process

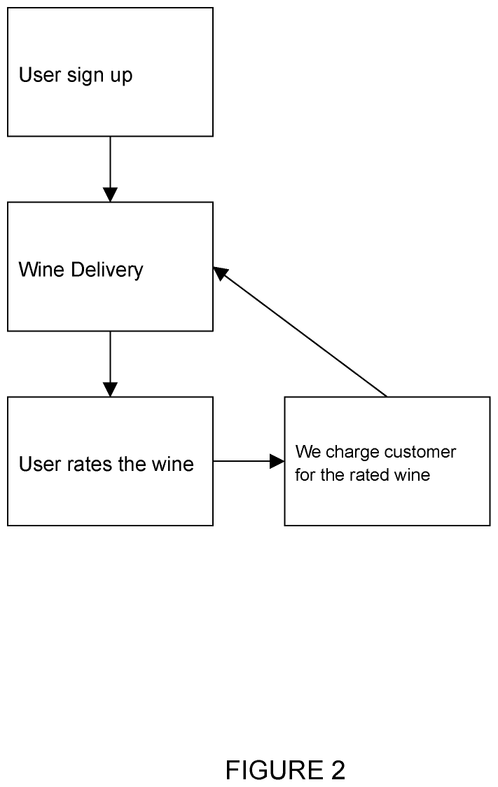

In a second example process, a user signs up to a wine delivery service, eg. by signing up using a user terminal in communication with a server. The wine delivery is sent by the service, and received by the user. The customer samples or consumes the wine, then sends a rating of the wine eg. from a user terminal in communication with a server, to the server. In response to receiving the rating (eg. at the server), the customer is charged for the rated wine, and a subsequent wine delivery is sent by the service, and received by the user. The customer samples or consumes the subsequently delivered wine, then sends a rating of the subsequently delivered wine eg. from a user terminal in communication with a server, to the server. The customer is then charged for the subsequent wine delivery, and the process repeats from the sending of the subsequent wine delivery, onwards. An example process diagram is shown in FIG. 2.

Third Example Process

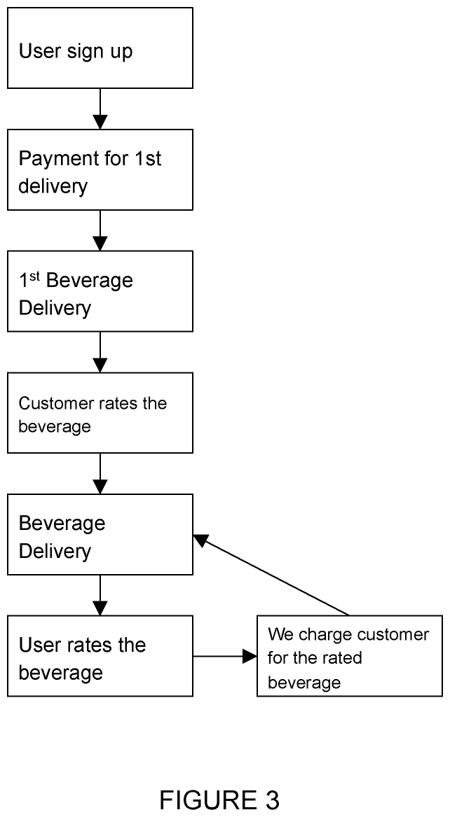

In a third example process, a user signs up to a beverage delivery service, eg. by signing up using a user terminal in communication with a server. The service (eg. the server) requests and receives a payment from the user for the first beverage delivery. The first beverage delivery is sent by the service, and received by the user. The customer samples or consumes the beverage, then sends a rating of the beverage eg. from a user terminal in communication with a server, to the server. In response to receiving the rating (eg. at the server), a subsequent beverage delivery is sent by the service, and received by the user. The customer samples or consumes the subsequently delivered beverage, then sends a rating of the subsequently delivered beverage eg. from a user terminal in communication with a server, to the server. The customer is then charged for the subsequent beverage delivery, and the process repeats from the sending of the subsequent beverage delivery, onwards. An example process diagram is shown in FIG. 3.

Fourth Example Process

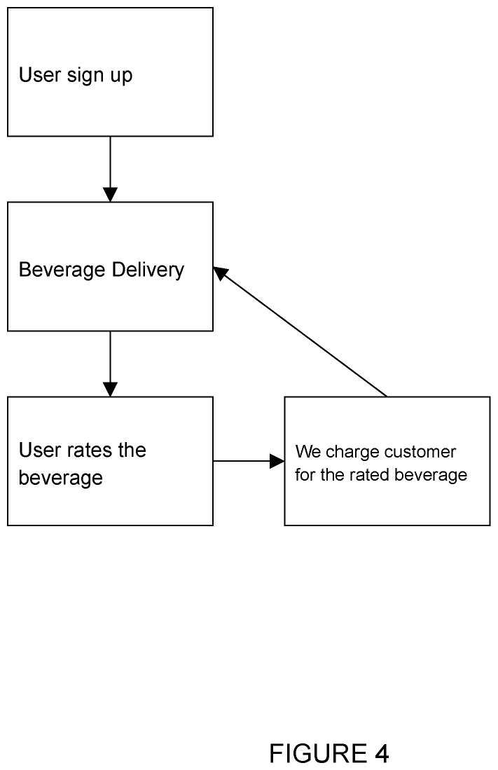

In a fourth example process, a user signs up to a beverage delivery service, eg. by signing up using a user terminal in communication with a server. The beverage delivery is sent by the service, and received by the user. The customer samples or consumes the beverage, then sends a rating of the beverage eg. from a user terminal in communication with a server, to the server. In response to receiving the rating (eg. at the server), the customer is charged for the rated beverage, and a subsequent beverage delivery is sent by the service, and received by the user. The customer samples or consumes the subsequently delivered beverage, then sends a rating of the subsequently delivered beverage eg. from a user terminal in communication with a server, to the server. The customer is then charged for the subsequent beverage delivery, and the process repeats from the sending of the subsequent beverage delivery, onwards. An example process diagram is shown in FIG. 4.

Blind Wine Service Example
Wine delivery service business model:
Customer signs-up for the wine delivery service.
Service delivers unbranded wines for the fixed price.
Customer rates the wine and instantly gets a wine name from the order.
recommendation engine uses rated wines for better wine selection for the next order.
Recommendation engine makes selection in a way that average order (wine cost+delivery) is lower than fixed price for a wine.
Service could offer different price levels (fixed price for the unlabeled wine bottle)—so user could select the higher priced one for the higher probability of more expensive wine.
user could select favorite wines from the past orders and order them one more time for fair market price (not for fixed price for unbranded bottle).
right after customer rates the wine, the service makes delivery of the next bottle
   there is an option to adjust the order
      quantity.
      red/white/sparkling/rose.
there is an option to:
   charge customer only when he rates the wine starting from first order.
   charge customer for the first order when he signs-up and then charge him for the next bottle when he rates the current order.
For the past orders, customer could always order a wine bottle he already tried but for the typical market price (not the fixed price which is announced for unlabeled bottles).
Instead of unlabeling bottles, the bottles could be sealed with non-transparent plastic/silicone.

Note

It is to be understood that the above-referenced arrangements are only illustrative of the application for the principles of the present invention. Numerous modifications and alternative arrangements can be devised without departing from the spirit and scope of the present invention. While the present invention has been shown in the drawings and fully described above with particularity and detail in connection with what is presently deemed to be the most practical and preferred example(s) of the invention, it will be apparent to those of ordinary skill in the art that numerous modifications can be made without departing from the principles and concepts of the invention as set forth herein.

1. System A system for receiving and storing unbiased user feedback about user perception of beverage quality, the system including a server, a computer database and a plurality of containers each including a respective beverage, each container including the respective beverage comprising a sealed container containing the respective beverage, wherein each container including the respective beverage has no marking which identifies the respective beverage to a user, wherein
(i) the server is configured to receive a registration of a user account from a user terminal in communication with the server, the user account including user account data including a user name and a user street address of a user, and the server is configured to store the user account data;
(ii) the server is configured to receive an order for a first container including a first beverage from the plurality of containers each including a respective beverage, wherein the server is configured to receive the order from a user terminal in communication with the server, in relation to the user account, and to store the order;
(iii) the server is configured to receive a confirmation of delivery of the first container including the first beverage to the user street address;
(iv) the server is configured to receive feedback in relation to the user account and the first container including the first beverage that was confirmed to have been delivered to the user street address, the feedback identifying the user's perception of a beverage quality of the first beverage, and
(v) the server is configured to store the feedback in the computer database.

2. The system of claim 1, wherein the beverage is an alcoholic beverage.

3. The system of claim 2, wherein the alcoholic beverage is wine, beer, cider, whisky, vodka, or sake.

4. The system of any previous claim 1, wherein each container including the respective beverage is a wine bottle including a wine.

5. The system of claim 1, wherein the beverage is a non-alcoholic beverage.

6. The system of claim 5, wherein the non-alcoholic beverage is supplied in dry form.

7. The system of claim 5, wherein the non-alcoholic beverage is tea or coffee.

8. The system of claim 1, wherein in response to receiving the feedback identifying the user's perception of the beverage quality, the server is configured to transmit the identity of the beverage to the user; or wherein in response to receiving the feedback identifying the user's perception of the beverage quality, the server is configured to transmit the identity of the beverage to the user, in which the server is configured to transmit the identity of the beverage to the user instantly, for display on a user terminal.

9. (canceled)

10. The system of claim 1, wherein the system includes a computer-based recommendation engine operable to select a beverage for a next order, based on beverage evaluations which have been stored at the server.

11. The system of claim 10, (i) wherein the beverage evaluations include beverage evaluations from a panel of experts; or (ii) wherein the beverage evaluations include beverage evaluations from users registered at the server; or (iii) wherein the beverage evaluations include wine evaluations; or (iv) wherein the system is configured to use beverage evaluations of the user, and the computer-based recommendation engine, to select a beverage for the next order which is more suitable for the user than if the beverage selected for the next order were to be selected at random.

12-14. (canceled)

15. The system of claim 1, wherein the server is configured to provide a user with an option to view their favorite beverages as stored in the computer database, wherein the favorite beverages as stored in the computer database, are the user's favorite beverages from past orders.

16-19. (canceled)

20. The system of claim 1, wherein the server is configured to provide a user with an option to view on a user terminal their previously received beverages as stored in the computer database.

21. The system of claim 1, wherein the server is configured to provide a user with an option to order a previously received beverage.

22. The system of claim 21, wherein the server is configured to provide a user with an option to order a previously received beverage, at a retail price, rather than at a fixed price for beverage containers for which the delivered beverage does not have an identifier through which the user can identify the beverage.

23. The system of claim 1, wherein a container including a respective beverage which has no marking which identifies the respective beverage to a user comprises a container from which usual labeling has been removed from the container.

24. The system of claim 1, wherein a container including a respective beverage which has no marking which identifies the respective beverage to a user comprises a container including a non-transparent coating which covers the container, or which covers its identifying labeling.

25. The system of claim 24, wherein the non-transparent coating is a plastic or silicone coating.

26. The system of claim 1, wherein a container including a respective beverage which has no marking which identifies the respective beverage to a user includes an identifier.

27. The system of claim 26, (i) wherein the identifier is for inventory purposes; or (ii) wherein the identifier is a serial number, a one dimensional bar code or a two dimensional pattern code; or (iii) wherein the server is configured to receive user input of the identifier, and to verify if the identifier is a valid identifier, and to store whether or not the identifier is valid.

28-29. (canceled)

30. The system of claim 1, wherein
(vi) the server is configured to receive a subsequent order for a second container including a second beverage from the plurality of containers each including a respective beverage, wherein the server is configured to receive the order from a user terminal in communication with the server, in relation to the user account, and to store the order;
(vii) the server is configured to receive a confirmation of delivery of the second container including the second beverage to the user street address;
(viii) the server is configured to receive feedback in relation to the user account and the second container including the second beverage that was confirmed to have been delivered to the user street address, the feedback identifying the user's perception of a beverage quality of the second beverage, and
(ix) the server is configured to store the feedback in the computer database.

31. A computer-implemented Computer implemented method for receiving and storing unbiased user feedback about user perception of beverage quality, the method including the steps of:
(i) a server receiving a registration of a user account from a user terminal in communication with the server, the user account including user account data including a user name and a user street address of a user, and the server storing the user account data;
(ii) the server receiving an order for a container including a beverage, the container including the beverage comprising a sealed container containing the beverage, wherein the container including the beverage has no marking which identifies the beverage to the user, the server receiving the order from a user terminal in communication with the server, in relation to the user account, and storing the order;
(iii) the server receiving a confirmation of delivery of the container including the beverage to the user street address;
(iv) the server receiving feedback in relation to the user account and the container including the beverage that was confirmed to have been delivered to the user street address, the feedback identifying the user's perception of a beverage quality of the beverage, and
(v) storing the feedback in a computer database.

32-69. (canceled)

70. Computer A computer program product executable on a server processor, for receiving and storing unbiased user feedback about user perception of beverage quality, the computer program product executable on the server processor to cause the server:
(i) to receive a registration of a user account from a user terminal, the user account including user account data including a user name and a user street address of a user, and to store the user account data;
(ii) to receive an order for a container including a beverage, the container including the beverage comprising a sealed container containing the beverage, wherein the container including the beverage has no marking which identifies the beverage to the user, the server receiving the order from a user terminal, in relation to the user account, and to store the order;
(iii) to receive a confirmation of delivery of the container including the beverage to the user street address;
(iv) to receive feedback in relation to the user account and the container including the beverage that was confirmed to have been delivered to the user street address, the feedback identifying the user's perception of a beverage quality of the beverage, and
(v) to store the feedback in a computer database.

71. (canceled)
